(19) United States
(12) Patent Application Publication
(10) Pub. No.: US 2008/0091727 A1
(43) Pub. Date: Apr. 17, 2008

(54) Innovation by analogy

(76) Inventors: Craig Burton Wynett, New Richmond, OH (US); Paul Anthony Zaffiro, Middletown, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/581,839

(22) Filed: Oct. 17, 2006

(51) Int. Cl. G06F 7/00

(52) U.S. Cl. 707/104.1

(57) ABSTRACT

Various methods, systems and tools are disclosed for solving problems by using analogical reasoning. In various embodiments, a structured approach is provided to problem solving by comparing generalized problem statements to analogous problems with known solutions.

### FIELD OF THE INVENTION

The invention generally relates to solving problems by use of analogous reasoning. In various embodiments, the invention more particularly relates to processes and systems for generating tangible solutions to technical problems in association with development of new products and/or services.

### BACKGROUND OF THE INVENTION

In general, the capability to develop effective solutions to solve difficult problems is a critical part of all business endeavors. In particular, the development of new products and services is an essential component to the continued success and viability of many commercial enterprises.

Various Internet-based search engines can be used to conduct research and development of new products and services. Many search engines use automated software programs that query millions of pages of text based on user specification of a keyword or phrase to attempt to uncover documents related to a product subject matter of interest. Search algorithms employed by search engines may use both raw similarity, as well as measures of relevance (like the frequency with which the record is retrieved, the newness of the information, and the number of other pages that link to the record) to attempt to identify relevant documents. The implicit assumption that underpins such keyword searches, however, is that the most relevant useful information regarding a particular subject can be found within conventional definitions of the product subject area. Therefore, such search strategies are often limited by the domain of the product area being searched and are not capable of drawing analogous relationships to other, potentially more relevant, product domains.

In the context of design teams attempting to solve problems, engaging in effective problem solving is usually a challenge. Team members often have difficulty with generalizing the problem to be solved. This is a critical issue because in order to identify suitable solutions, the design team must develop retrieval cues that focus on relational information about the problem being solved, rather than on surface characteristics of the domain of the specific problem area. Thus, tools are needed to help design teams develop generic representations of problems to be solved. In addition, the ability of a design team to retrieve and evaluate analogous solutions is limited by the extent of human knowledge readily accessible to the team. A human being knows only a fraction of all available knowledge in the world at any given time. A brainstorming session, for example, while sometimes useful for identifying solutions to problems, can be negatively impacted by limitations on the collective knowledge base of its human participants.

In view of the foregoing issues, more effective and efficient strategies, methods, systems, and tools are needed for solving problems such as new product and/or service development.

### SUMMARY OF THE INVENTION

The invention provides various methods, systems and tools for solving problems by using analogical reasoning.

In one embodiment, an analogic method for developing technical solutions to a technical problem is provided. The method may include the steps of defining a specific technical problem to be solved and identifying a generalized problem statement that encompasses the specific technical problem to be solved. The method may further include identifying one or more specific technical problem solutions corresponding to the generalized problem statement, wherein the one or more specific technical problem solutions are obtained from a database comprising one or more specific technical problem solutions and one or more specific technical problems for one or more of a plurality of generalized problems. The method may also include displaying the specific technical problem solutions that correspond to the generalized problem statement.

In another embodiment, a system for developing technical solutions to technical problems is provided. The system may include (a) a reference database comprising specific technical solutions to specific technical problems; and, (b) a reference database comprising a plurality of generalized types of problems, wherein at least one of the specific technical solutions of the reference database of element (a) is categorized as corresponding to at least one of the generalized types of problems. The system may also include an interface module in communication with at least one of the reference databases, the interface module being operative to: display to a user the plurality of generalized problems; receive a selection from the user of the generalized problem that corresponds to a specific problem that the user desires to solve; and, display one or more specific solutions from the database of element (a) corresponding to the selected generalized problem.

In another embodiment, a computer-readable medium including instructions for executing an analogic method for developing technical solutions to technical problems is provided. The medium may include instructions for receiving data associated with a specific technical problem to be solved, and instructions for facilitating identification of a generalized problem statement that encompasses the specific technical problem to be solved. The medium may also include instructions for identifying one or more specific technical problem solutions corresponding to the generalized problem statement, wherein the one or more specific technical problem solutions are obtained from a database comprising one or more specific technical problem solutions and one or more specific technical problems for one or more of a plurality of generalized problems. The medium may further include instructions for displaying the one or more specific technical problem solutions corresponding to the generalized problem statement.

### BRIEF DESCRIPTION OF THE DRAWINGS

The utility of the embodiments of the invention will be readily appreciated and understood from consideration of the following description when viewed in connection with the accompanying drawings, wherein:

FIG. 1 includes a process flow diagram illustrating aspects of a method provided in accordance with embodiments of the invention;

FIG. 2 includes a schematic system architecture diagram in accordance with various embodiments of the invention;

FIG. 3 includes a tabulation of various trends of technical evolution that may be applied in association with embodiments of the invention;

FIG. 4 includes an example of a radar plot that may be used for defining problems in association with embodiments of the invention;

FIG. 5 includes a graphical example of a product trend that may be used for defining problems in association with embodiments of the invention;

FIG. 6 includes a schematic illustrating development of a generalized problem statement in association with embodiments of the invention;

FIG. 7 includes a schematic illustrating matching relationships between a problem statement and an analogous solution;

FIG. 8 is a sample screen display from a database of problems/solutions structured in accordance with embodiments of the invention;

FIG. 9 includes a schematic system architecture diagram in accordance with various embodiments of the invention;

FIGS. 10 through 13 include schematic representations of certain aspects of knowledge tools that may be used in association with various embodiments of the invention;

FIG. 14 includes a sample excerpt from a query that can be executed in association with various embodiments of the invention; and,

FIG. 15 includes a sample screen display structured in accordance with various system embodiments of the invention.

### DETAILED DESCRIPTION OF THE INVENTION

As applied herein, the term “technical” as used in the context of solutions and problems, for example, may include both technological problems and solutions (e.g., in the chemical arts, electrical arts, mechanical arts, electromechanical arts, etc.), as well as business process related problems and solutions.

In the context of development of the invention, the inventors have recognized that abstract, seemingly unsolvable problems can be frequently solved by finding and adapting solutions to similar problems from often distant or unrelated knowledge domains through analogical problem solving. In various embodiments, the invention may employ the following methodology: find a problem or breakthrough problem to solve; generalize the problem to reveal its conceptual core; identify or define an analogous problem that may or may not have a known solution; and, if the analogy of the solved problem suggests a viable solution, adapt the analogous solution to solve the new problem. As described below, a benefit of the invention can be realized by providing methods, systems and tools that help design teams or other users find analogies not within their current knowledge base. For example, in certain embodiments, the invention provides tools for creating text queries or other queries that can be used on existing databases (e.g., a patent database) to maximize the likelihood that the design team can find analogous problems from other problem domains that provide potential solutions.

The inventors have also recognized that, in the case of breakthrough problem solving, one begins with the belief that there is no known or obvious solution to the problem. This leaves the problem-solver with trying to find an analogous problem that already has a solution. A keyword search based on the literal specification of the problem is unlikely to retrieve a useful analogy, however, or to uncover an analogy in which two problems or solutions from different domains have matching or corresponding relationships. For example, as seen herein in the context of an illustrative bleach problem, a clothing stain removal problem is analogous to the problem faced by an oncologist when dealing with a patient who has a cancerous tumor. Radiation strong enough to kill the tumor may also undesirably kill surrounding healthy tissue. One way the doctor can solve this problem is by targeting periodic low doses of chemotherapy to treat the tumor. Thus, both problems (i.e., how to remove the stain and how to destroy the cancer) can be conceptualized as “collateral damage” problems in which a target (i.e., stain/tumor) must be eliminated while preserving valuable non-target resources (i.e., fabric/healthy tissue). Given this matching of relationships between the different problems, a solution can be adapted from one problem to solve the other problem. For example, low doses of bleach could be applied to a clothing stain until it is removed, while minimizing negative impact to the surrounding fabric. In addition, there may be many other potential solutions to such “collateral damage” problems. It can be seen that a benefit of the invention arises from characterizing the problem in terms of abstract relationship to maximize the potential solutions that can be found.

It can be seen that embodiments of the invention, as described in more detail below, provide many benefits. The invention allows individuals who are not skilled or naturally adept at making unobvious connections to consistently make these types of connections. As a result, these individuals are able to maximize their creative capacity. When the invention is applied in the area of new product and/or service development, for example, it enables individuals and teams to generate innovations that otherwise might not have been generated. Embodiments of the invention leverage the way the human mind works. Principles of cognitive psychology teach that the mind is always seeking to find similarity between current thought and something stored in memory. The invention builds on this insight by motivating thoughts about problems in a way that draws innovative solutions from memory. This is in contrast to brainstorming methodologies, for example, which do not provide structured and relevant cues to aid retrieval. In various embodiments, the invention provides tools to assist design teams and other users in creating enhanced and more effective database queries, for example.

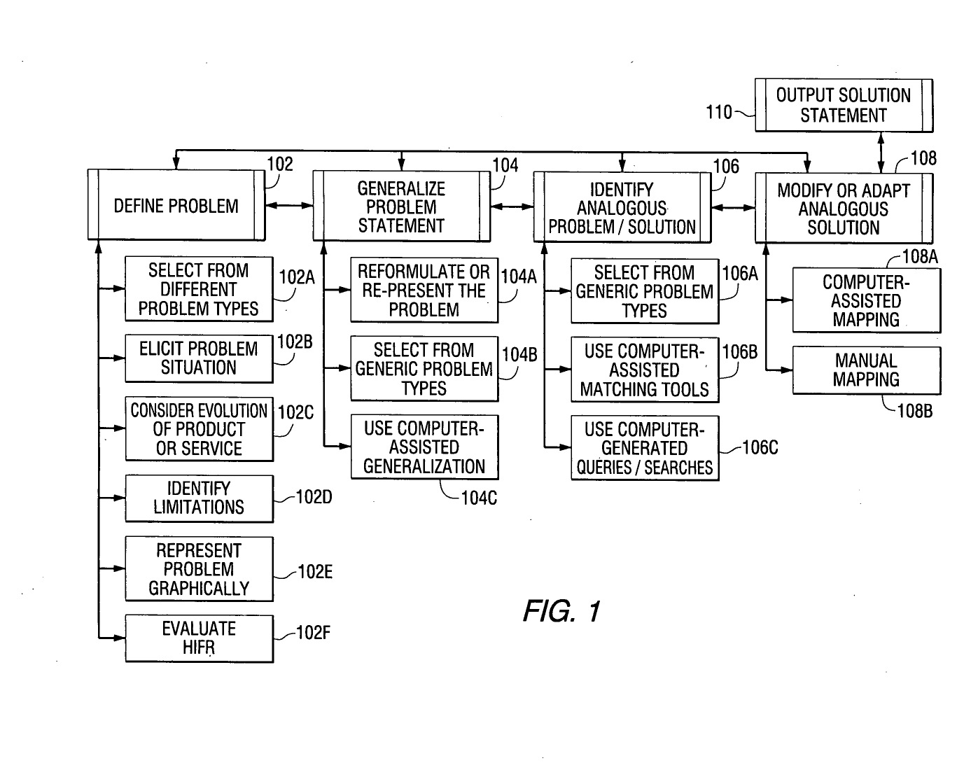

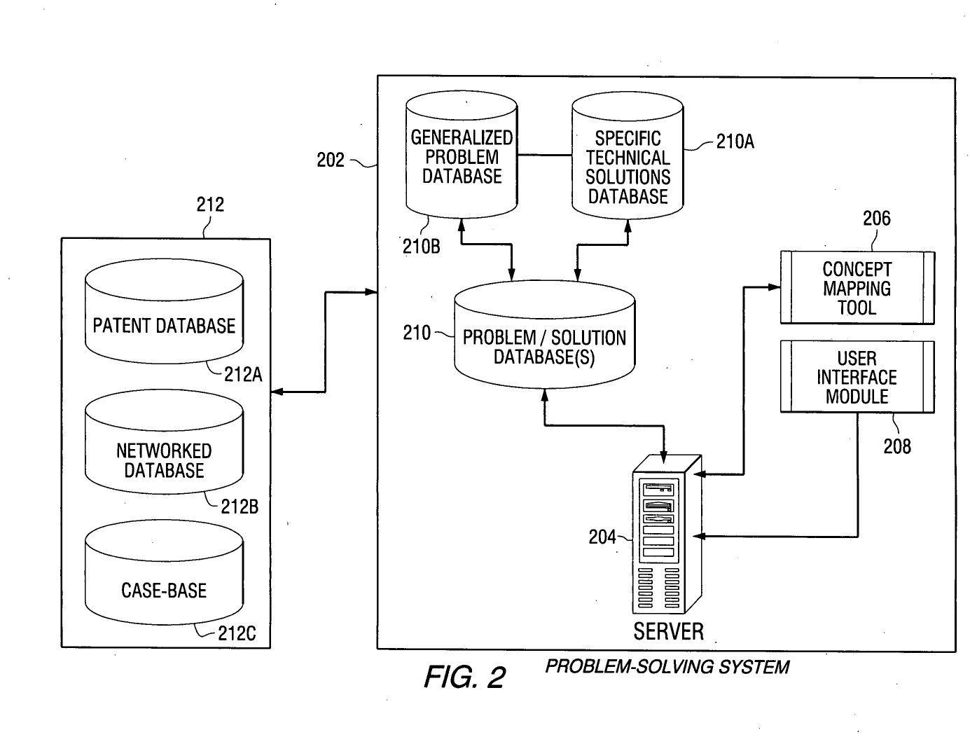

With reference to FIGS. 1 and 2, in various illustrative embodiments, the invention provides a methodology and a problem-solving system 202 for developing solutions to various problems. In various embodiments, an analogic method is provided for developing technical solutions to a technical problem. The analogic method may be executed in association with operation of the problem-solving system 202 for developing technical solutions to a technical problem, for example. As described in more detail below, the system 202 may include a server 204 (e.g., a web server), or another suitable computer system, and various databases, software modules, and/or other components that assist with problem-solving functions performed or assisted by the system 202.

At step 102, the method may include defining a problem or specific technical problem to be solved, such as by a product design team, for example, an individual user, and/or other problem-solvers. The defined problem may involve at least one product or service, and/or may employ a product trend for defining the problem to be solved. One goal of step 102 is to add detail to the problem situation. This defining step 102 may be viewed as adding “surface area” to the problem. It reveals aspects of the problem situation, often surfacing questions and assumptions that have not been previously articulated.

In certain aspects of defining the problem at step 102, problems whose solution may result in a breakthrough or substantially significant result can be considered. As shown in step 102A, for example, defining the problem may include selecting a problem type or class. Classes of solutions for problems that result in a breakthrough may include, for example and without limitation: problems in which one aspect of a system degrades when another aspect is improved (e.g., making a razor sharper also increases its propensity to be unsafe); problems in which the solution is counter-intuitive (e.g., instead of a credit card that requires payment of interest, a credit card that makes payments to the holder); or, problems for which the solution involves a way to use an unexploited resource to deliver a new benefit (e.g., a window that harnesses the sun, wind, and rain to clean windows rather than spot them).

In various embodiments, a computer-implemented concept mapping tool 206 of the problem-solving system 202 may be employed in association with defining the problem at step 102. The concept mapping tool 206 may be embodied as a tool for putting text or language in shapes or blocks, for example, in a graphical environment and then connecting the shapes based on the logical or causal relationships between and/or among the text or language. Many suitable concept mapping tools 206 are known to those skilled in the art, including “CmapTools” provided by IHMC (http://cmap.ihmc.us), for example.

In certain embodiments, a concept map developed through use of the concept mapping tool 206 may be linked to one or more concept libraries, for example, or other suitable sources of linguistic information. Through this operative association of the concept mapping tool 206 with the concept library, step 102 may involve creating a representation of the problem that a computer system can understand and process. One approach is to use concept mapping tools 206 for which an ontology or linguistic architecture has already been established. One example of such an ontology is the “CLIB” ontology (as described in Barker, K., Clark, P., and Porter, B. A Library of Generic Concepts for Composing Knowledge Bases. Proc. 1st Int. Conf. on Knowledge Capture (K-Cap '01), 2001.). Other examples of ontologies that might be employed include “Cyc” (marketed by Cycorp, Inc. http://www.cyc.com) and “Ontolingua” (offered by Stanford University. http://www.ksl.stanford.edu/software/ontolingua/). Another possible approach involves applying a linguistic parser analysis to a verbal description of the defined problem, or using a similar machine translation process, to translate the problem into concepts executable by a computer system.

To further assist with the problem definition activity of step 102, in certain embodiments at step 102B the method may include using a plot template tool, for example, for eliciting the problem situation verbally, such as from a team of product developers or other users. One goal of step 102B is to add detail to the problem situation or problem definition. The plot template tool can be used to motivate the team to view the problem from a new perspective (i.e., from the perspective of an author writing a story). In operation of step 102B, the following questions may be employed to develop and refine the problem definition, for example and without limitation: who is the principle character? what is the beginning state? what is the goal state (i.e., the quest)? who are the key supporting characters? what key events occur along the way? what barriers hinder the quest? what are the key relationships between the characters? It can be seen that step 102B may involve using a story/plot metaphor tool to elicit detail on the problem situation and help a design team, for example, to “tell the story” of the problem situation. This tool may also involve identifying or evaluating key conflicts, contradictions, and trade-offs associated with the problem.

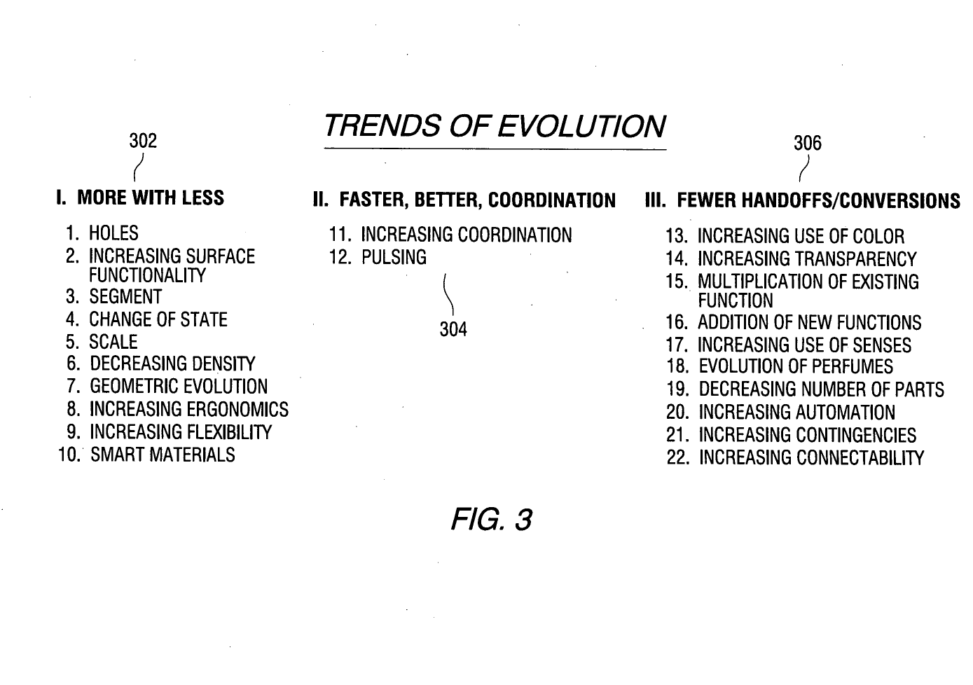

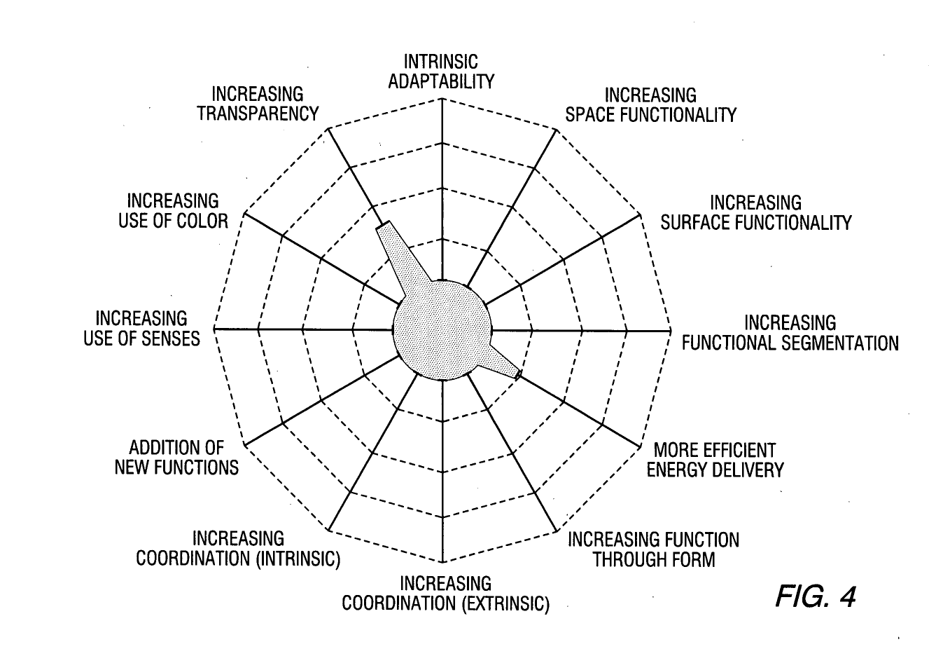

At step 102C, evolution of a product or service may be considered, including one or more evolutionary trends of technologies, products, and/or services, to assist with definition of the problem. With reference to FIG. 3, for example, trends of technical evolution for products or services may be grouped, for clarity of illustration, into different categories: a “more with less” category 302; a “faster, better, coordination” category 304; and, a “fewer handoffs/conversions” category 306, as shown. Each of the categories 302, 304, 306, may include one or more sub-categories that can be used to elicit potential opportunities or areas for potential improvement to define a problem for a given product or service. The exemplary radar plot of FIG. 4 illustrates a potential graphical representation of examples of the evolutionary trends potentially applicable to a given product or service, including several of the exemplary sub-categories listed in FIG. 3. By using the radar plot, a user may be able to identify areas of improvement opportunity for the product or service.

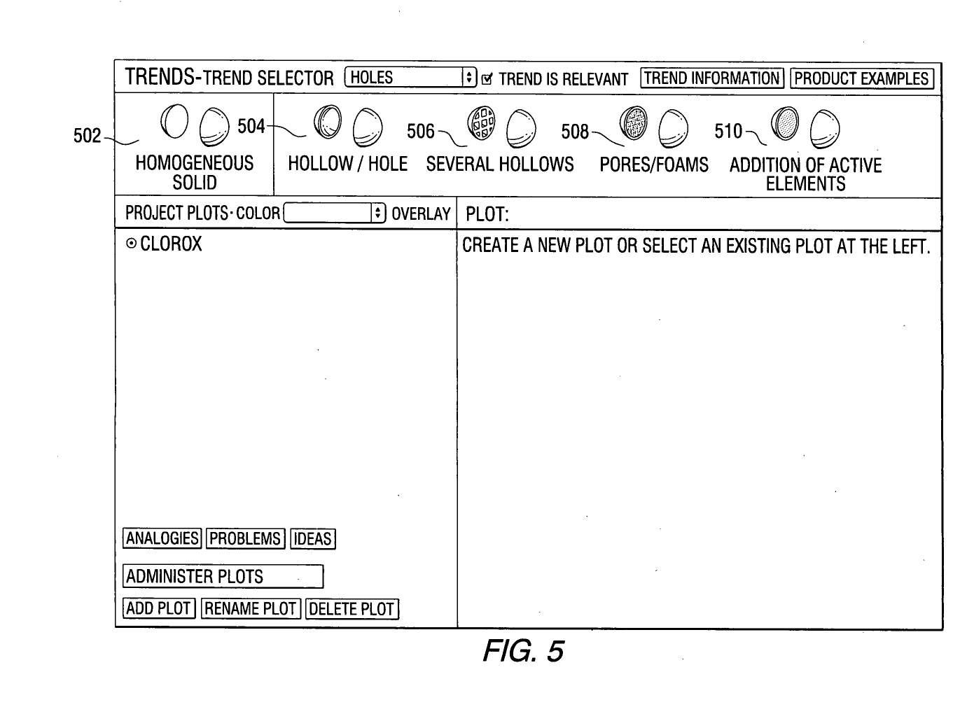

With reference to FIG. 5, another graphical example of a technical evolution trend is illustrated at various stages 502-510. It can be appreciated that such graphical representations of technical evolution trends may be useful in assisting with defining the problem at step 102. The categories 302, 304, 306 and their respective sub-categories, as well as the sample graphical representations depicted in FIGS. 4 and 5, may be accessed by users through a user interface module 208 or another display functionality associated with the problem-solving system 202.

At step 102D, one or more limitations may be identified in association with defining the problem. Such limitations may be embodied as constraints on the solution space and may be technical, commercial, legal (e.g., intellectual property related), financial, political, and/or organizational. For example, a team may want to develop a breakthrough solution but may also be constrained to bring a product or service to market within a specified time limit (e.g., within a year). Another example of a potential limitation scenario is a preference for incremental solutions over breakthrough solutions. Examples of tools and processes that may be applied in association with step 102D include, without limitation, quality function deployment (“QFD”), Kano diagrams, activity diagrams, and consumer research.

At step 102E, the problem statement may be represented graphically such as by using the concept mapping tool 206, for example, in a format that may be executable by a computer system.

At step 102F, defining the problem statement may be assisted by use of an HIFR (Holistic Ideal Final Result) tool that may involve a discussion of an ideal solution to the problem from the consumer's perspective. For example, suppose that a problem-solving team is tasked with designing a better lawnmower. When the team considers what consumers want in a lawnmower, statements such as “a lawnmower that uses less gas” or “a lawnmower that is smaller so that it can be stored more easily” may be elicited. Ultimately, the team begins to realize that what the consumer wants as the HIFR is grass that is perfectly cut, all the time. This leads to the further realization that eventually the lawnmower could become obsolete. With this realization, the team begins to work backward from the HIFR to the present situation, mapping business choices along the way. In this manner, the team is able to make an explicit business decision in light of the evolution of the industry. The HIFR tool may also be useful for identifying trade-offs. For example, the consumer may want the lawnmower to be sufficiently wide to cut as much grass as quickly as possible, but also sufficiently narrow for easy storage. The solution to this trade-off may result in a breakthrough solution.

As an example of a problem that may be defined at step 102, optionally by performing one or more of steps 102A-102F, the problem statement of “how to get bleach to target and remove a stain but not damage the surrounding unstained fabric” may be defined.

In various embodiments, the problem-solving system 202 may include one or more problem/solution databases 210. The databases 210 may include a reference database comprising specific technical solutions to specific technical problems 210A, and/or a reference database comprising a plurality of generalized types of problems 210B. The specific technical solutions of the reference database 210A can be categorized as corresponding to at least one of the generalized types of problems stored in the reference database 210B. The interface module 208 may be configured for communication with one or both of the reference databases 210A, 210B, among other databases 210. The interface module 208 may be operative to perform one or more of the following functions: display to a user a plurality of generalized problems; receive a selection from the user of the generalized problem that corresponds to a specific problem that the user desires to solve; and/or, display one or more specific solutions from the reference database 210A corresponding to the selected generalized problem stored in the database 210B.

In various embodiments, the system 202 may suggest a tool or template for a user to employ in defining the problem, for example. The system 202, based on user input associated with the problem, may help the user select a tool or template based on programmed case-based reasoning, for example, and may accept input on the problem description into that tool or template.

The system 202 may also allow users to input problems, solutions, strategies and other information for the purpose of developing a repository of valuable problem-solving information and data for the system 202. It can be seen that, over the course of time as the system 202 is employed to solve various problems, a valuable repository of problems and their associated solutions can be developed which may represent a tremendous asset to the corporation or other entity that employs the system 202.

At step 104, the method may further include generalizing a problem statement that encompasses the specific technical problem to be solved. In this step, the problem can be defined using generic language or terms independent of the domain or particular product and/or service area of the defined problem. In various embodiments, the generalized problem statement may be identified manually by a design team, for example, or may be automated or semi-automated in its creation by one or more functions of the problem-solving system 202. In certain embodiments, the system 202 may employ a computer-implemented semantic analysis or semantic parser configured to process the defined problem to suggest one or more generalized problems, perhaps in a list of multiple generalized problems prioritized by their relevance to the defined problem. In various embodiments, the system 202 may also be configured to present a list of generalized problems to the user and may be configured to suggest one or more generalized problems in a prioritized list, for example.

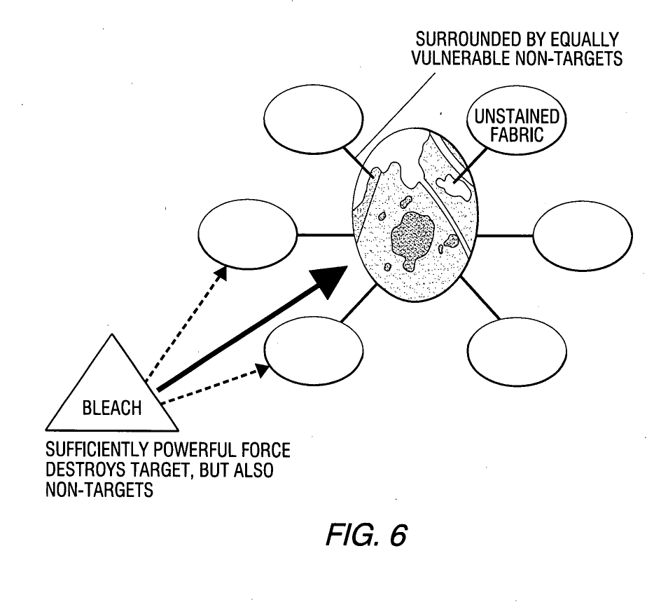

As an example of the operation of step 104, the specific defined problem of “how to get bleach to target and remove a stain but not damage the surrounding unstained fabric” can be considered a domain-specific representation of the problem, using terms specific to the laundry/bleaching technology area. In various embodiments, the method at step 104 may involve developing a generalized statement including the defined problem to be solved and in terms comparatively more general than the terms used for defining the problem to be solved. Thus, in terms of the present example, the defined bleaching problem can be generalized as follows: “how to get a powerful agent to focus and act on a specific target while minimizing the impact on surrounding or nearby non-targets” as illustrated schematically in FIG. 6.

At step 104A, generalizing a problem statement may include reformulating or re-presenting the problem statement. Step 104A may be accomplished by using a NIST Function database, by applying one or more ontologies to the problem statement (either manually or by use of a computer system), and/or by labeling or abstracting a causal explanation for the problem statement, among other tools, techniques and processes known to those skilled in the art. In various embodiments, generalizing the problem statement at step 104 may be an iterative process, or may involve iteratively re-casting the generalized statement. As described below in more detail, in certain embodiments the concept mapping tool 206 may be employed as part of the problem-solving system 202 for developing and/or re-casting the generalized problem statement.

At step 104B, the generalized problem statement may be selected from the database of a plurality of generalized problem statements 210A, for example. It can be seen that the generalized statement may include terms independent of the domain of the defined problem to be solved.

As shown at step 104C, computer-assisted tools may be employed to assist with generalization of the problem statement. Examples of tools and processes that may be used at step 104C include, without limitation, a generalizer mutator (as described below), or a linguistic generalizer applied to a verbal problem description. The process of generalizing the problem statement may also be automated or semi-automated by configuring the system 202 to recommend one or more generalized problems based on semantic analysis of the specific problem definition, for example.

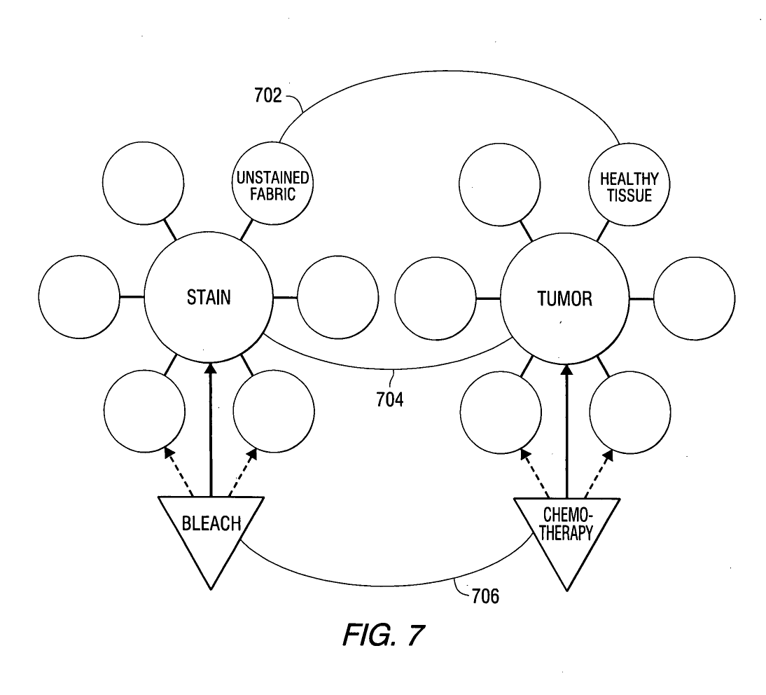

With reference to FIG. 7, at step 106, embodiments of the method may also involve evaluating a plurality of specific technical problem solutions corresponding to the selected generalized problem. The plurality of specific technical problem solutions may be obtained from the database comprising a plurality of specific technical problem solutions 210B for each of the plurality of generalized problems, for example. Embodiments of the method may also include selecting one or more specific technical problem solutions at step 106A subject to evaluating the specific technical solutions. In operation, step 106 may involve accessing or reviewing one or more of the problem/solution databases 210, or other storage media, operatively associated with the problem-solving system 202. The objective is to find analogous problems with one or more relationships 702, 704, 706 that are at least similar to a set of core relationships of the defined problem to be solved.

At step 106, the developed or selected generalized problem statement may be applied against problems and solutions stored in one or more of the databases 210 to identify matching or corresponding relationships. To facilitate this matching function of the system 202, the stored problems and solutions, including generalized problems and solutions, may be indexed by one or more aspects, such as by analogy, problem description, and/or problem type, for example, or a number of other aspects. The problems and solutions in the databases 210 may be indexed by metatag information, for example, or another suitable mechanism that facilitates their identification and retrieval during a problem-solving activity. In certain embodiments, it may be desirable to associate analogous problems in the system 202 with one or more known solutions. It can be appreciated that the solutions to the identified analogous problems may suggest strategies that can be used to solve the defined problem.

In various embodiments, the search for an analogous problem/solution may be assisted at step 106B by the use of computer-implemented tools, such as by using a matching tool (see discussion below) for locating an analogous problem/solution in a case-base or case library. At step 106C, one or more computer-generated queries or searches may be initiated by the problem-solving system 202. In one example embodiment, the problem-solving system 202 may employ a concept library operatively associated with “WordNet” (http://wordnet.princeton.edu/) to create and execute a text query search on a search engine known to those skilled in the art.

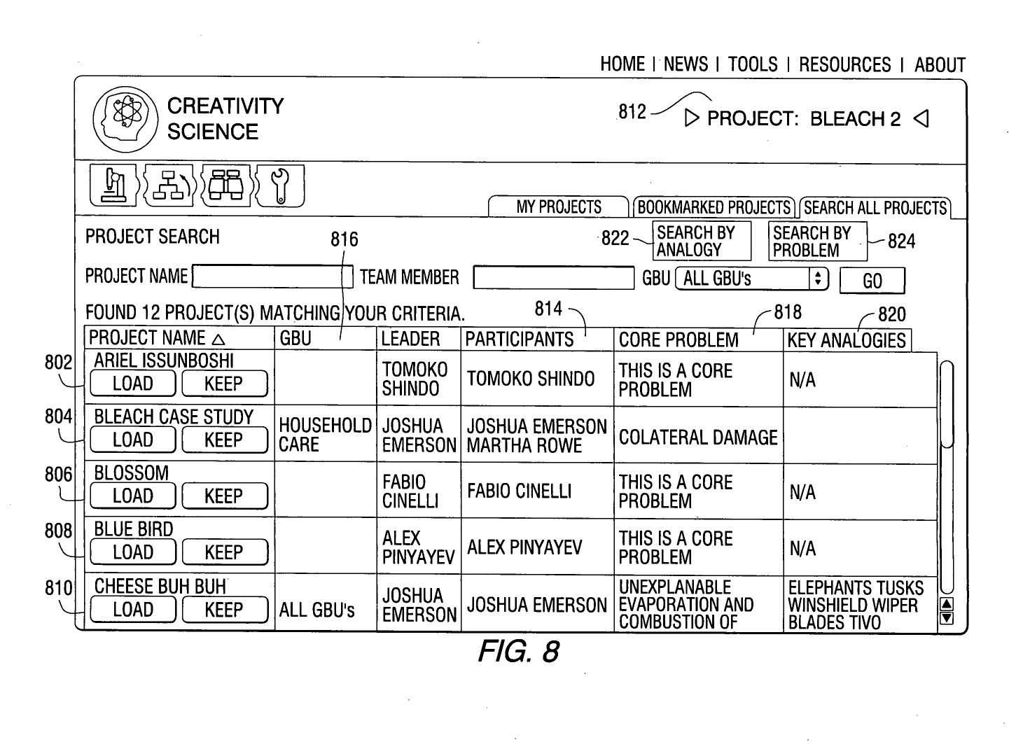

As shown in the example of FIG. 8, the problem/solution databases 210 may include one or more projects 802-810, for example, or analogous problems that may have relationships or other features that match or correspond with a relationship or other feature of the defined problem. One or more portions of the generic solutions in the databases 210 may be indexed by the key causal relationship in one or more analogies, which can be designated as a function or key technology, for example. In addition, problems and solutions stored in the databases 210 may be indexed by theme or generalized problem type. In various embodiments, the plurality of specific technical problem solutions stored in the databases 210 may be indexed by one or more themes. The system 202 may also be operatively associated with one or more other internal or external databases 212, such as a patent database 212A, a networked database 212B (e.g., intranet, extranet, Internet, or other networked media), and/or a case-base database 212C that can be searched in association with identifying one or more problems analogous to the generalized statement. Such databases 210, 212 may also list technologies and/or strategies that deliver the designated functions.

In operation of certain aspects of the system 202, design teams or other users can create one or more projects, such as projects 802-810, as described above. The ideas, problems, analogies and/or solutions associated with a given project can be linked and stored with a certain project identifier to facilitate subsequent searching and review. In the illustrative example shown, a user can edit a project name description 812, add team members or participants 814, attach a GBU or global business unit 816 to the project; update core problem data 818; update key analogies data 820; and/or, upload an SLR, or a smart learning report, which may be a document describing the solution for a given project. In various embodiments, each of the projects 802-810 may have an associated generic problem type which can be stored in the database 210 and displayed in a field for each project 802-810. In various embodiments, tools that permit a user to search information stored in the databases 210 by analogy (e.g., button 822) or problem (e.g., button 824) can be provided.

With reference again to step 106 of the present bleach example, one or more of the following analogous problems may be considered, such as by reviewing the problem/solution databases 210, for example: aerial bombs—hit the target, avoid “collateral damage”; ground campaign—kill the enemy, avoid “friendly fire”; taser—stop the suspect, don't kill him; screening air travelers—detain the bad guys, let the good guys board; immune function—attack non-self, spare self; cancer treatments—harm cancer cells but not normal cells; anti-microbial treatments—kill pathogens, don't kill the host; or, signal detection theory—maximize/minimize noise. With reference again to FIG. 7, in the present bleach example, the cancer treatment problem can be identified as an analogous problem (with a known solution) potentially suitable for application to the problem defined at step 102.

In various embodiments, at step 108 the method may include adapting or modifying one or more of the selected specific technical solutions to adapt it for application to the specific technical problem to be solved. This step 108 may involve evaluating an identified analogous problem/solution for suitability for application to the defined problem by attempting to map or identify at least one matching relationship between the defined problem and the identified analogous problem/solution. In various embodiments, adapting relationally similar aspects of the analogous solution to the problem may involve computer-assisted mapping (see step 108A) and/or manual mapping (see step 108B) of the matching relationships.

For example, in identifying cancer treatment as an analogous problem to the bleach problem, various insight relationships can be considered for the cancer treatment problem such as, different agents affect different phases of the cell cycle due to differential energy demands; non-specific drugs like alkylating agents have linear dose response curves; cell-cycle specific agents are schedule dependent—increasing cell kill is done by extending duration of exposure not by increasing dose; maximize cell kill while minimizing host toxicities by using agents with non-overlapping dose-limiting toxicities; increase the range of drug activity against tumor cells with endogenous resistance to specific types of therapy; prevent or slow the development of newly resistant tumor cells; different sensitivities of the target sites to drug effects; based on body surface area which is highly correlated with clearance rates; and, targeting of aberrant proteins. In addition, certain cancer treatment strategies can be considered, such as segmenting the tumor based on cell kinetics; multi-agent therapy; using statins to cut blood supply to tumors; molecularly targeted therapies (i.e., tagging); biologically targeted therapies; and, pulsing of sub-lethal doses. In the context of the present example, pulsing of sub-lethal doses can be identified as a strategy that may be applicable to the bleach problem.

At step 108, the method may include adapting at least one of the evaluated analogous problems to develop a solution to the defined problem. Also, adapting the evaluated analogous problem may involve extracting at least one generic solution strategy from the evaluated analogous problem. This step 108 may be complex, depending on the complexity of the problem and the evaluated analogous solutions. In chemotherapy, for example, one strategy employed by oncologists is to administer several sub-lethal doses over an extended period of time. No one dose destroys the tumor; however, the cumulative effect does destroy the cancerous tumor while preserving the healthy surrounding tissue. This strategy gives rise to the idea of “pulsing” the application of bleach in the laundry process. Rather than dosing bleach all at one time, bleach can be administered in several doses during wash process. Other potential adaptations of the chemotherapy strategy that may be applicable to the bleach problem include multiple weak doses of bleach and/or complimentary chemistry; applying bleach at different points in the laundry cycle; using a “cocktail” of multiple chemistries that together target stains more than background fabric; preventing staining/loss of brighteners; chemical tagging on whites to activate bleaching only on those areas; and, using bleach resistant coating on virgin fabric to resist negative effects on non-stained areas. These and other aspects of the chemotherapy treatment problem/solution may be stored in one or more of the databases 210 for access by the system 202.

At step 110, the solution to the defined problem may be outputted by the problem-solving system 202, such as through the user interface module 208, for example, as a tangible solution statement. The solution to the defined problem may also be displayed in a variety of media that may be visible to a user of the system 202, and/or may be retained in an internal memory or other storage medium of the system 202. Examples of other suitable output devices and mechanisms include, without limitation, screen displays, monitors, graphical user interfaces, or other media for graphical representation of data and information. In the context of the present bleach example, the solution statement may be output at step 110 as follows: “pulsing sub-lethal doses of bleach over multiple treatments or cycles significantly reduces collateral damage to unstained fabric” or an equivalent expression. In various embodiments, the method may further comprise testing one or more of the selected specific technical solutions that have been modified or adapted for application to the specific technical problem.

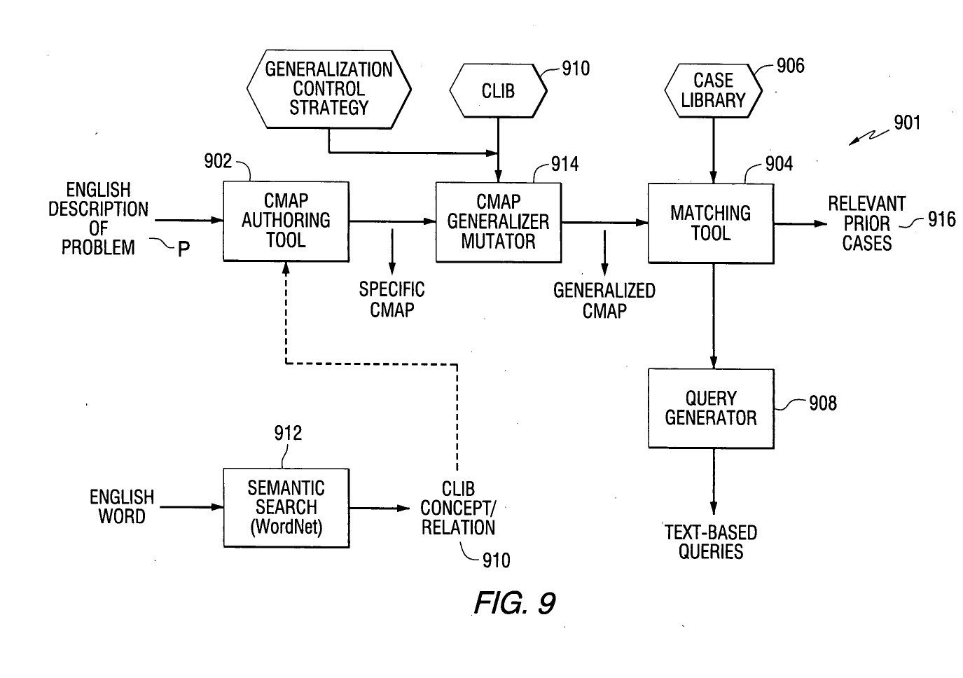

With general reference to FIGS. 9 through 14, various examples of knowledge elicitation tools and other tools that may be used in association with embodiments of the invention are illustrated. In general, a problem-solving system 901 may be provided with a concept mapping tool 902 for creating a visual representation of a problem which can be understood or processed by a computer or computer system. The mapping tool 902 may be a user-directed generalization tool for creating generic problem representations. The system 901 may also employ a matching tool 904 capable of matching generalized concept maps against a library or case-base of themes 906 to identify classes of solutions that may be relevant to the defined problem. In certain embodiments, a query generator 908 may be employed to create queries (e.g., text queries) to one or more databases 210, 212, or other data or information sources, based on the developed problem representation.

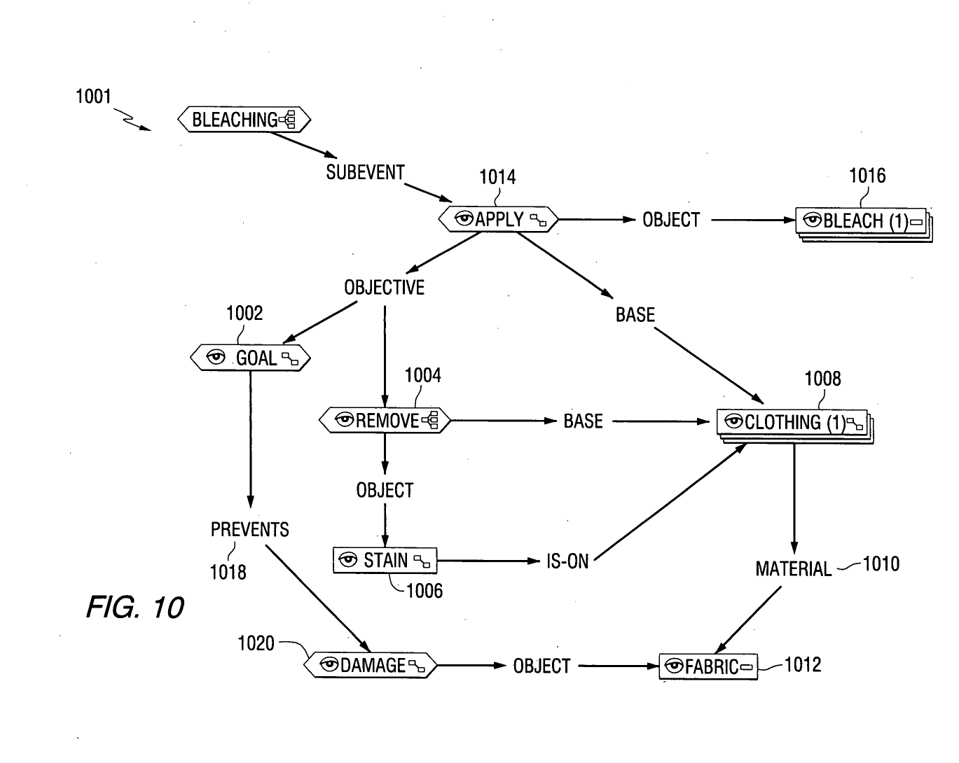

As shown in FIG. 10, and with reference again to the bleach problem, a concept map 1001 may be generated and encoded in a computer-readable format. The mapping tool 902 facilitates applying actions, events, sub-events, objectives, “is-on” relationships, and other linguistic relationships to the various elements of a problem statement. In the concept map 1001, the “bleaching” problem is represented with the “goal” 1002 of desiring to “remove” 1004 a “stain” 1006 from “clothing” 1008 (or “material” 1010 such as “fabric” 1012) through application (i.e., “apply” 1014) of “bleach” 1016 in a manner that “prevents” 1018 certain “damage” 1020 to the “fabric” 1012, among other elements in the concept map 1002. The nodes and links on the concept map 1002 may be drawn from concepts in a concept library 910 (e.g., “CLIB”), for example. The concept library 910 may include a selection of synonymous terms from which a user may select a more general expression of a given portion or term of a specific problem statement. Thus, the mapping tool 902 aids in the conversion of a text problem statement P, for example, from domain-specific terms to equivalent terms stored in the concept library 910 to the specific concept map 1002. In addition, a conventional semantic search tool 912 (e.g., “WordNet”) may be applied in association with the mapping tool 902 to identify terms for defining the problem statement.

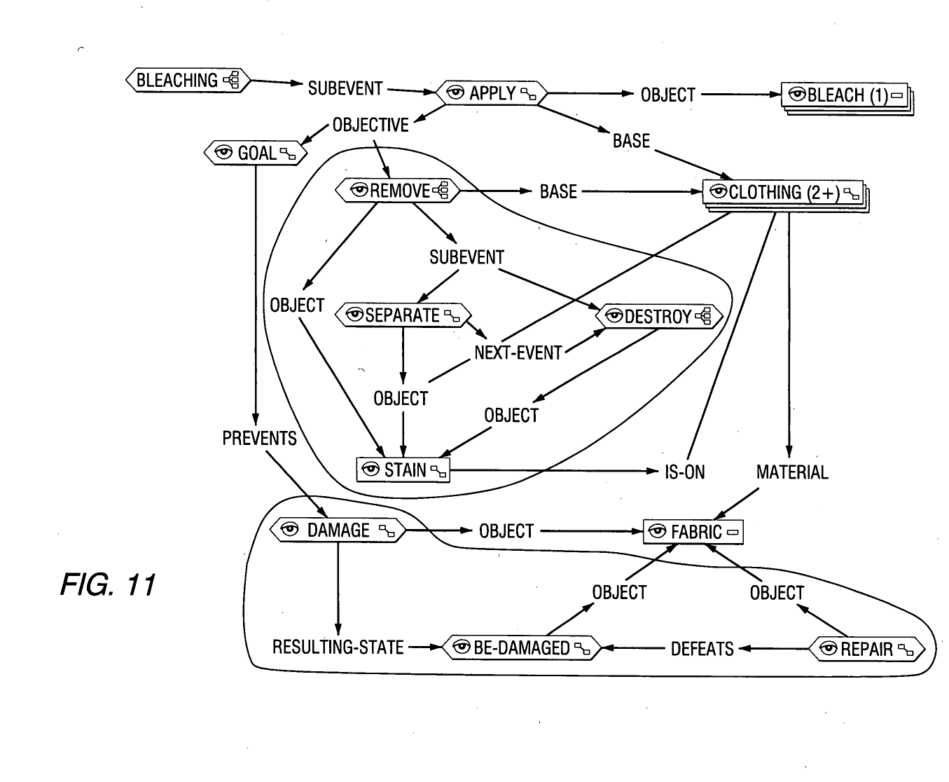

As shown in FIG. 11, the concept map 1002 can be generalized with a generalizer mutator 914 of the system 901, which is configured to move up the concept hierarchy within the component library 910 and locate domain-independent equivalents of specific terms contained within the defined problem statement. Various relational concepts may be decomposed into their elemental meanings during this generalization process to generate a generalized problem statement. In the present example, the system 901 has determined that “Removing X from Y” means “Separating X and Y and then Destroying Y.” This decomposition suggests that other ways of “Separating” the stain from the fabric should be considered (e.g., consider stain barriers instead of removers).

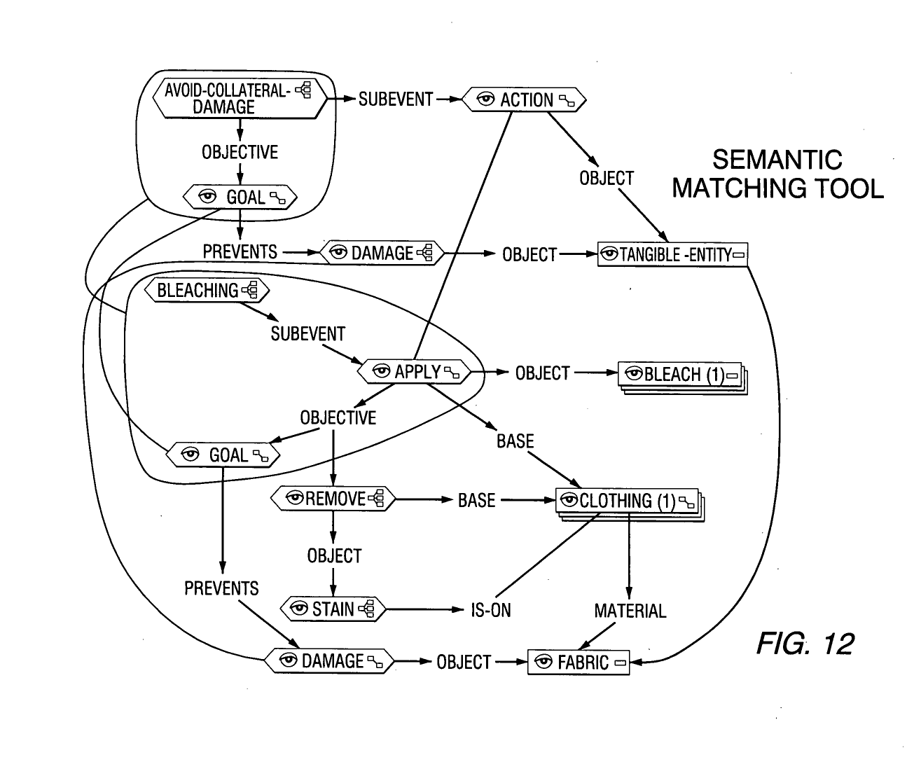

With reference to FIG. 12, the generalized problem statement may be used in association with the matching tool 904 to identify one or more relevant prior cases 916 or analogous problems, potentially with known solutions. The matching tool 904 may function in association with the query generator 908 to query a data memory or text queries may be generated from a specific CMAP and fed into an advanced search capability in a conventional Internet search engine, for example. This may involve generating a query based on comparing the library of themes 906 to the defined problem or the generalized problem statement to identify one or more analogous problems. The queries may be executed on the databases 210, 212, for example, and/or through a networked medium (e.g., intranet, extranet, Internet, etc.). In various embodiments, the case-base library 906 can be used in association with the matching tool 904 to link specific problems to generalized themes that represent problem solutions. The generalized problem can be compared against the case-base library 906 to suggest other avenues for solution. In various embodiments, queries generated by the query generator 908 can also be used as queries to memory, either individually or in the team setting. It can be seen that computer-generated retrieval cues may be a way to assess and cultivate the collective memories of a design team, for example.

As shown in FIG. 12, the matching tool 904 may employ a semantic matching tool, for example, to perform a comparison between generalized problems and the library of themes 906. In the context of the present bleach example, the matching tool 904 has identified that the “collateral damage” theme applies to the bleaching problem. Thus, various embodiments of the invention employ a library of themes 906 operatively associated with the concept mapping tool 902 for comparing at least a portion of the contents of the library of themes 906 to the defined problem or the generalized problem statement. The matching tool 904 seeks to identify potentially matching or corresponding relationships between the defined problem or the generalized problem statement and the library of themes 906. Examples of matching or corresponding relationships may include similar goals, actions, or objects.

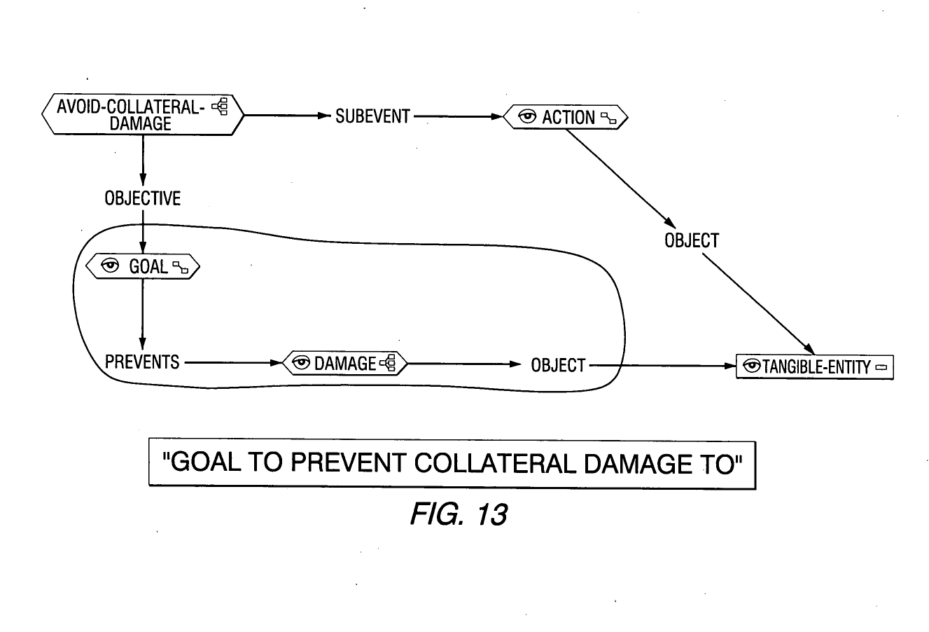

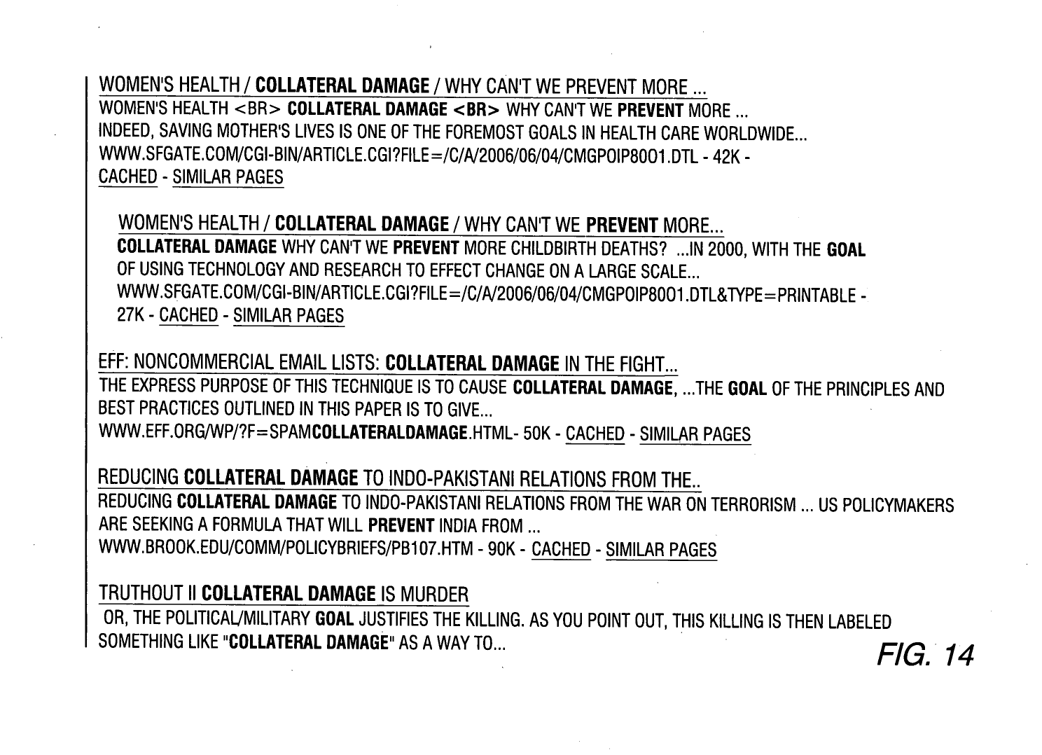

With reference to FIG. 13, once the system 901 recognizes that the collateral damage theme applies to the bleach problem, or “goal to prevent collateral damage to” as a statement, the search can commence for analogous solutions. In various embodiments, queries executed by Internet search engines, for example, may be employed with the concept library 910 and the “WordNet” semantic search tool 912, for example, to execute a query including the “goal to prevent collateral damage to” statement. The illustrative search results of FIG. 14 display what may be uncovered when such a query is executed on a conventional Internet search engine (e.g., “www.google.com”). Other data or information sources to which the query can be applied may include the databases 210, 212, or other sources. The results derived from performing these searches may be used to augment the case library 906, for example, with additional examples of problems that have been solved.

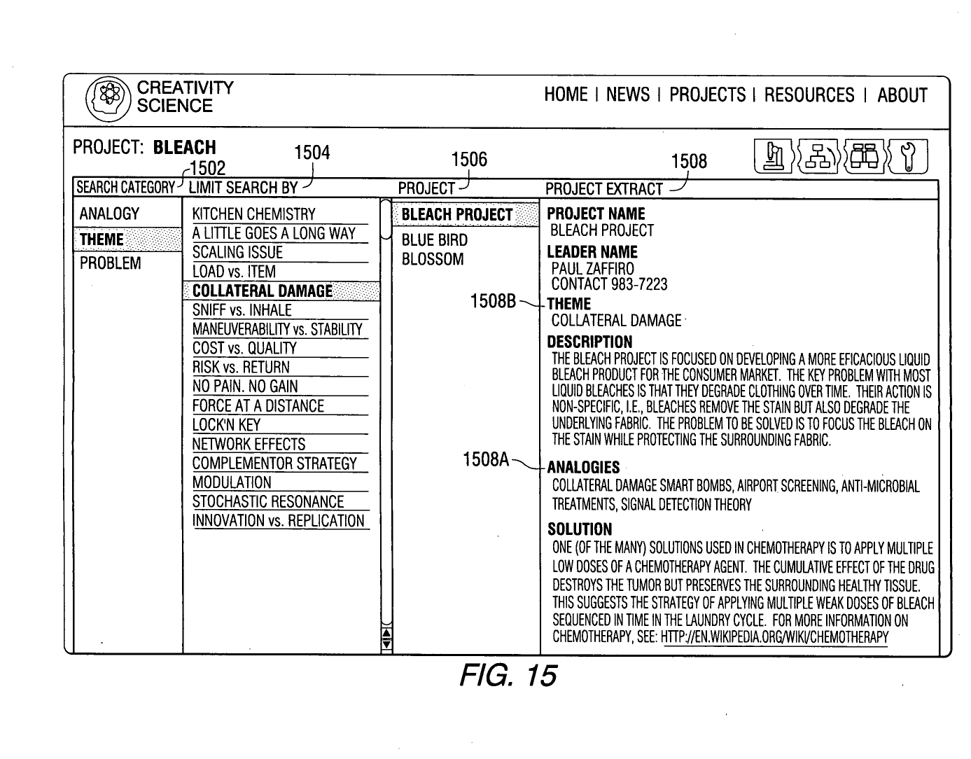

With reference to FIG. 15, various examples of the search capabilities and other functional aspects of the problem-solving system 202 are illustrated. As shown, the analogy search portal (ASP) allows a user to search the databases 210 by analogy, by problem, and/or by theme or generalized problem type. In this example, a search category 1502 of “theme” has been selected by the user, which causes the system 202 to display various “Limit Search By” themes 1504, as shown. The user selects the “Collateral Damage” theme 1504 and the system 202 returns a list of projects 1506 that correspond to or match with the selected “Limit Search By” theme 1504. In certain embodiments, specific problems and solutions may be displayed in the project 1506 section. The user then selects the “Bleach Project” project 1506, and this action causes the system 202 to display a project extract 1508 for the project 1506. An analogy section 1508A of the project extract 1508 includes analogy information for the project, which illustrates generalized problems stored in the system 202 by using one or more illustrative examples. In this example, “collateral damage” has been stored as a theme 1508B with respect to one or more projects 1506 stored in one or more databases 210 of the system 202. As shown in section 1508A, collateral damage in a warfare context (e.g., “smart bombs”) is included as an example of the generalized collateral damage problem theme 1508B. It can be seen that the ASP of the system 202 permits the user to move readily from project to project, searching by analogy, for example.

In various embodiments, the problem-solving system 202 may maintain or store an audit history of one or more user transactions that occur when the system 202 is employed. This audit history may be stored in the databases 210 of the system 202 and may reflect one or more aspects of the problem-solving process, including without limitation, problem definition, selection or creation of generalized statements, identification of analogous problems and solutions, and/or problem solutions displayed or output by the system 202. It can be seen that such an audit history may be a further tool for identifying and adapting analogous problems and solutions to a defined problem.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for receiving, storing and/or processing data for standalone application and/or over a networked medium or media. For example, a computer system that can be employed in association with various embodiments of the invention may include a processor, one or more databases or other suitable data storage media, and one or more interface modules for receiving and displaying information and accepting functional commands or data entry from users.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like computer-readable media.

In general, computer-readable media may include any medium capable of being a carrier for an electronic signal representative of data stored, communicated or processed in accordance with embodiments of the present invention. Where applicable, method steps described herein may be embodied or executed as instructions stored on a computer-readable medium or media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted or modified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An analogic method for developing technical solutions to a technical problem, comprising the steps of:
a. defining a specific technical problem to be solved;
b. identifying a generalized problem statement that encompasses the specific technical problem to be solved;
c. identifying one or more specific technical problem solutions corresponding to the generalized problem statement, wherein the one or more specific technical problem solutions are obtained from a database comprising one or more specific technical problem solutions and one or more specific technical problems for one or more of a plurality of generalized problems; and,
d. displaying the one or more specific technical problem solutions corresponding to the generalized problem statement.

2. The method of claim 1, further comprising selecting one or more of the identified specific technical problem solutions.

3. The method of claim 1, further comprising modifying one or more of the selected specific technical problem solutions to adapt it for application to the specific technical problem to be solved.

4. The method of claim 3, further comprising testing one or more of the selected specific technical problem solutions that have been modified for application to the specific technical problem.

5. The method of claim 1, wherein at least one of the one or more specific technical problem solutions in the database is indexed by at least one theme.

6. The method of claim 1, wherein at least one of the one or more specific technical problems in the database is indexed by at least one theme.

7. The method of claim 1, wherein identifying the generalized problem statement includes selecting the generalized problem statement from a database of a plurality of generalized problems.

8. The method of claim 7, wherein at least one of the generalized problems is indexed in the database by at least one theme.

9. The method of claim 1, further comprising outputting a solution statement associated with the solution to the defined problem.

10. The method of claim 1, wherein the defined problem involves at least one product or service.

11. The method of claim 1, wherein the database is a database selected from the group consisting of a patent database, a networked database, and a case-base.

12. The method of claim 1, further comprising employing an evolution trend for defining the problem to be solved.

13. The method of claim 1, further comprising generating a query based on the generalized problem statement.

14. The method of claim 13, further comprising executing the query on a database.

15. The method of claim 13, further comprising executing the query through a networked medium.

16. A system for developing technical solutions to technical problems, the system comprising:
a. a reference database comprising specific technical solutions to specific technical problems;
b. a reference database comprising a plurality of generalized types of problems, wherein at least one of the specific technical solutions of the reference database of element (a) is categorized as corresponding to at least one of the generalized types of problems;
c. an interface module in communication with at least one of the reference databases, the interface module being operative to:
i. display to a user the plurality of generalized problems;
ii. receive a selection from the user of the generalized problem that corresponds to a specific problem that the user desires to solve; and,
iii. display one or more specific solutions from the database of element (a) corresponding to the selected generalized problem.

17. The system of claim 16, further comprising a server operatively associated with at least one of the reference database comprising specific technical solutions to specific technical problems, the reference database comprising a plurality of generalized types of problems databases, or the interface module.

18. A computer-readable medium comprising instructions for causing a computer system to execute an analogic method for developing technical solutions to a technical problem, the medium comprising:
a. instructions for receiving data associated with a specific technical problem to be solved;
b. instructions for facilitating identification of a generalized problem statement that encompasses the specific technical problem to be solved;
c. instructions for identifying one or more specific technical problem solutions corresponding to the generalized problem statement, wherein the one or more specific technical problem solutions are obtained from a database comprising one or more specific technical problem solutions and one or more specific technical problems for one or more of a plurality of generalized problems; and,
d. instructions for displaying the one or more specific technical problem solutions corresponding to the generalized problem statement.

19. The medium of claim 18, further comprising instructions for presenting at least one suggested tool or template to a user for assisting the user with entering data associated with the specific technical problem to be solved.

20. The medium of claim 18, further comprising instructions for presenting a plurality of generalized problems to the user.

21. The medium of claim 18, further comprising instructions for illustrating at least one generalized problem by presenting at least one example of the generalized problem.

22. A computer-readable medium comprising instructions for causing a computer system to execute an analogic method for developing technical solutions to a specific technical problem to be solved, the medium comprising:
a. instructions for receiving data comprising a generalized problem statement that encompasses the specific technical problem to be solved;
b. instructions for identifying one or more specific technical problem solutions corresponding to the generalized problem statement, wherein the one or more specific technical problem solutions are obtained from a database comprising one or more specific technical problem solutions and one or more specific technical problems for one or more of a plurality of generalized problems; and,
c. instructions for displaying the one or more specific technical problem solutions corresponding to the generalized problem statement.
